(19) United States
(12) Patent Application Publication
(10) Pub. No.: US 2026/0303764 A1
(43) Pub. Date: Oct. 1, 2026

(54) PORTABLE DEVICE FOR DISPLAYING GRAPHICAL INFORMATION ON A REMOTE OBJECT

(71) Applicant: EXTEND3D GMBH, München (DE)

(72) Inventors: Peter KEITLER, München (DE); Nicolas HEUSER, München (DE)

(21) Appl. No.: 19/477,878

(22) PCT Filed: Apr. 26, 2024
(86) PCT No.: PCT/EP2024/061530

§ 371 Date: Oct. 23, 2025

(30) Foreign Application Priority Data
Apr. 27, 2023 (DE) 10 2023 110 967.7

(51) Int. Cl. H04N 9/31; G06T 7/521

(52) U.S. Cl. CPC H04N 9/3185; G06T 7/521; H04N 9/3152; H04N 9/3161

(57) ABSTRACT

A portable device for displaying graphic information on a remote object including a video projector, a camera, a semitransparent mirror with first and second surfaces, and a control device. The projector, the camera and the mirror are accommodated in a portable housing and arranged such that the first surface of the mirror is in the beam path of the projector and the second surface is in the viewing angle of the camera. In a coaxial area of the device, either the optical axis of the beam path of the projector deflected by reflection by the mirror is coaxial with the optical axis of the incidence of light on the camera transmitted by the mirror, or the optical axis of the beam path of the projector transmitted by the mirror is coaxial with the optical axis of the incidence of light on the camera deflected by reflection by the mirror.

### FIELD OF THE INVENTION

The invention relates to a portable device for displaying graphic information on a remote object.

### BACKGROUND

WO 2012/136345 A2 discloses a system for visually displaying information on real objects, having a projection unit for graphically or pictorially transmitting an item of information to an object. The system comprises a dynamic tracking device having a 3D sensor system for determining and tracking the pose (position and orientation) of the object and a control device for the projection unit, which adjusts the transmission of the item of information to the current pose of the object as determined by the tracking device and displays it correctly in the right position (or perspective). Such a system can be used to enhance the efficiency of manual work steps in production, assembly, and maintenance and, at the same time, to increase the quality of work. The precise transmission of information, for example the digital planning status (CAD model) directly to a workpiece, makes the complex and error-prone transmission of construction plans by means of templates and other measuring instruments dispensable. A visual variance comparison can be performed at any time and intuitively for a user. In addition, work instructions, e.g., step-by-step guidance, can be made available directly at the work object or in the field of view of the user, that is, exactly where they are actually needed.

### SUMMARY

It is the object of the invention to provide a more compact, robust, and cost-effective projection assistance system that is flexible and versatile in its application.

This object is achieved by a portable device having the features set forth in claim 1. Advantageous and expedient configurations of the device according to the invention are indicated in the dependent claims.

The portable device according to the invention for displaying graphic information on a remote object comprises a projector, in particular a video projector, for projecting the graphic information, a camera for capturing the position and/or location of the object, a semitransparent mirror having a first surface and an opposite second surface, and a control device for controlling the projector and the camera and for evaluating the images captured by the camera. The device further comprises a portable housing in which at least the projector, the camera and the semitransparent mirror are accommodated. The projector, the camera and the semitransparent mirror are arranged in relation to each other such that the first surface of the semitransparent mirror is located in the beam path of the projector and the second surface of the semitransparent mirror is located in the viewing angle of the camera. In a coaxial area of the device, either the optical axis of the beam path of the projector deflected by reflection by the semitransparent mirror is coaxial with the optical axis of the incidence of light on the camera transmitted by the semitransparent mirror, or the optical axis of the beam path of the projector transmitted by the semitransparent mirror is coaxial with the optical axis of the incidence of light on the camera deflected by reflection by the semitransparent mirror.

For the purposes of the invention, a “portable device” is understood to mean a device in which at least the projector, the camera, and the semitransparent mirror are accommodated in a common housing that can generally be carried by a user alone and be placed at a suitable location, including on a tripod if required. Of course, a fixed installation is also possible. The device may, for example, be integrated into a production environment, such as on a hall ceiling or on a crossbeam.

In connection with the device according to the invention, an “optical axis” can essentially be equated with the principal axis of the respective optical system (projector or camera), wherein minor deviations can be covered or algorithmically corrected by a mathematical model, or more precisely, intrinsic calibration. The principal axis (central axis) of a projection cone or light incidence cone deflected by one or more mirrors is also referred to as the optical axis of the respective beam path.

A “semitransparent” mirror can have different transmission/reflection properties. The ratio of transmission to reflection in the relevant wavelength range may, for example, be about 50:50, 60:40, 70:30, 40:60, etc., although, of course, neither of the two proportions should be extremely small. It depends on the specific application of the device whether a configuration that deviates from the 50:50 ratio is more suitable, for example, to enable better measurement or to get more light onto the object surface.

The control device, which may consist of one or more components, is also necessary for operating the device. As will be discussed in more detail below, essential components of the control device may also be accommodated inside the housing of the device or be provided separately outside the housing, in which case the external components need to be connected to the projector, the camera and, if applicable, further electronic components in the housing of the device (by cable or wirelessly).

The invention is based on the finding that, thanks to the beam splitting, the semitransparent mirror can be used to implement a particularly compact, mobile projection system providing sufficient power for many applications, in which an “in-line arrangement” of the projector and the camera is simulated. This means that the projector and the camera have an identical perspective, whereby parallax errors and shadowing are avoided.

The device according to the invention can be employed in a wide variety of fields of application, such as in the skilled trades and construction industry, for example for the correct positioning of electrical/plumbing installations, or in the industrial sector, in particular for assembly support. Owing to its compact design, the device according to the invention is portable and, owing to the fixed and protected arrangement of the components in a common housing, it is also very robust and therefore ideally suited for the above-mentioned applications. But also certain industrial applications, such as the installation of brackets in confined aircraft fuselage barrels, can only be usefully implemented with such a compact device.

According to a first concept, essential components of the control device are also accommodated within the housing. In this case, the device is particularly mobile, since apart from the power supply (unless battery operation is provided), only a simple operating device or a laptop or tablet is required for operation. All other components of the device required for its functioning are contained in the portable housing, and the device is ready for immediate use.

According to a second concept, essential components of the control device in particular the control components responsible for the control logic-are intentionally not accommodated in the housing. The other components of the device that are accommodated in the housing can then be arranged even more compactly, so that this part of the device can be designed to be even smaller and more lightweight. In addition, this concept has the advantage that the control device can be designed to be more flexible and can be modified more easily. In this case, prior to operating the device, it has to be made sure that the components to be controlled or evaluated are connected to the components of the control device that are provided outside the housing.

In a particularly advantageous further development of the device according to the invention, provided in the coaxial area of the device is a scanning system with a mirror arrangement which is adapted to be moved by a drive and by means of which the coaxial optical axes of the projector and of the camera can be jointly deflected in different spatial directions, the drive being controlled by the control device. An appropriate control of the mirror device allows the projection field of the projector and the field of view of the camera to be significantly expanded. Of course, it should be appreciated here that it is not possible to illuminate the entire accessible area at the same time. For many applications, however, sequential illumination is entirely sufficient.

According to a first variant of the scanning system, the mirror arrangement includes two rotating mirrors and the drive includes two galvanometer drives. This scanning technology is well-proven and allows very fast deflections.

According to a second variant of the scanning system, the mirror arrangement includes only one scanning mirror that is rotatable about at least two axes. Such scanning mirrors are already commercially available for many commonly used large projectors, although the concept is also transferable to small projectors.

In a further particularly advantageous further development of the invention, there is provided in the coaxial area of the device a lens unit by means of which the beam path of the projector and the incidence of light on the camera can be automatically focused and/or automatically zoomed (automatic change in the focal lengths of the camera and the projector). By appropriately adjusting the lens unit, the working distance (distance between the device and the object onto which the projection is made) is automatically selected or automatically changed as required.

Ideally, the lens unit provided in the coaxial area of the device is sufficient for the intended use, so that the projector and the camera do not need to have lenses of their own. The device can then be constructed to be correspondingly simpler and more compact, for example by positioning the DLP chip of the projector and the CCD/CMOS sensor of the camera on the respective axes in the beam path at a consistent distance from the lens.

The projector of the device is preferably a video projector. In particular in conjunction with a movable mirror arrangement, a very compact, so-called “pico” video projector can be used, which has a comparatively low light output and a larger focal length and thus a smaller projection field at a given working distance. Such pico video projectors are not only reasonably priced, but also very energy-efficient and easy to protect due to their small dimensions and low waste heat.

But a laser projector, in particular with a point laser source, may also be used as the projector.

In an alternative, cost-effective embodiment, a compact light source is employed as the projector, which projects a simple geometric shape, such as a circle or a cross. The light source may be an LED pattern projector which can generate various shapes by means of interchangeable pattern masks, or a laser diode which can generate various patterns by means of a diffractive optical element. In particular in combination with a scanning system, cost advantages can be gained compared to a laser projector, since a slower deflection mechanism is sufficient, because when using a point laser source, it is not necessary to achieve the impression of a stationary contour, but only to direct the pattern already projected by the light source onto the desired position. A further advantage of the lower acceleration values is reduced wear, so that a longer service life can be attained. While this embodiment is not very flexible in terms of the achievable projection contents (fixedly configured pattern or a small number of patterns that can be statically configured using pattern masks), it is nevertheless sufficient for a large number of operator guidance applications.

The camera of the device is typically a conventional 2D camera. In a more sophisticated embodiment, a depth camera (3D camera or time-of-flight (ToF) camera) may be employed instead. Using such a camera, a point cloud is generated permanently and at a high update rate on the respectively targeted detail on the component. The ToF camera typically operates in the infrared (IR) range. The light is emitted and is evaluated with regard to depth information by means of time-of-flight measurement or interferometrically by means of correlation of the outgoing and reflected light waves on the detector. The measurement is performed on a sensor with many measuring points (pixels). If the sensor has a sufficient number of pixels, it also generates a 2D image having intensity values in the IR range. As a result, 2D and 3D information is available for each pixel.

The 3D image may be used for evaluation as an alternative or in addition to the 2D camera image. “Evaluation” here refers, for one thing, to “registration” or “tracking” and, for another, to “recognition/checking of the correct assembly of add-on parts”. Depending on the type of component, 3D data may in some circumstances be better suited for these intended uses. This is the case in particular if the component does not have clear and distinct corners, edges, holes, or similar features that would allow clear segmentation in the 2D camera image, but rather exhibits a homogeneous, continuously curved surface. On such surfaces, 3D point clouds can be simply “latched” for “referencing/tracking” or can be simply matched directly with the 3D model for “recognition/checking”. It will be appreciated that the “latching” requires the presence of elements in all three spatial directions; this means that it does not work, e.g., on a planar tabletop surface (because the point cloud could be arbitrarily shifted on it), but it works very well on convexly or concavely curved components. Since ToF cameras have significantly lower resolutions (currently typically 640×480 pixels) than conventional 2D cameras, an embodiment involving deflection of the viewing area by means of a movable mirror arrangement having one or more mirrors is particularly advantageous, since this still allows a high resolution to be achieved on the respectively targeted image area on the component. In principle, this advantage related to resolution is similar to that when using a pico video projector and, in particular, allows greater precision.

In order to make the device according to the invention even more compact and low-cost, a simple laser rangefinder may be used instead of a ToF camera to determine, in one direction, the distance to the object onto which the projection is made. The distance measurement may be performed based on laser time-of-flight measurement or interferometry. In simple terms, such a laser rangefinder functionally corresponds to a ToF camera with only one pixel. Although this measuring principle only allows one depth measurement to be taken at a given point in time, deflection by means of a scanning system allows different spatial directions and, hence, points on the target environment to be approached sequentially (rather than in parallel for many pixels of the ToF camera). Such an embodiment is advantageous in particular when only a few points are needed, such as for referencing to the remote or distant object (workpiece) or for a simple check of the presence of add-on parts (e.g., is there a plug already seated in the hole?). In this case, the measuring points can be determined in a sufficiently short time even with a relatively slow deflection unit (irrespective of the number of mirrors of the scanning system).

The projector of the device according to the invention may also comprise a plurality of different projector units, namely at least one of a video projector unit, a pico video projector unit, a laser projector unit, an LED pattern projector unit, and a laser diode unit. Using such a multifunctional projector, the projection method that is best suited to the respective application can either be employed individually or a combination of different projector units can be used at the same time, which furthermore opens up new possible applications that would not be feasible with a single projector unit.

A particularly advantageous combination is obtained in particular with a simple LED pattern projector unit and a laser projector unit having a point laser source with a diffractive optical element. A device that includes these two projector units constitutes an ultra-compact and extremely low-cost solution for operator guidance for somewhat less dynamic contexts. The LED pattern projector unit and the depth sensor here are either coupled into a beam path by means of the semitransparent mirror (as with the other variants already described); here, the point laser source can be also used at the same time for a time-of-flight measurement or an interferometric measurement with the aid of the control device, i.e., it can take over this functional part of a laser rangefinder. In the case of interferometric measurement, the laser light is also guided onto separate optical paths by means of the semitransparent mirror acting as a beam splitter-to fulfill the different functions- and is then reflected by additional mirrors at the respective end of the path and ultimately merged again.

It is also possible to provide a plurality of cameras in the device, in particular different cameras, such as a 2D camera and a 3D camera, or at least one camera, in particular a 2D camera, together with a laser rangefinder. This allows the range of functions of the device to be significantly expanded.

According to a special embodiment, the semitransparent mirror is provided with a polarizing filter.

### BRIEF DESCRIPTION OF THE DRAWINGS

Further features and advantages of the invention will be apparent from the description below and from the accompanying drawings, to which reference is made and in which:

FIG. 1 shows a schematic illustration of a device according to the invention in a first embodiment;

FIG. 2 shows a schematic illustration of a device according to the invention in a second embodiment;

FIG. 3 shows a schematic illustration of a device according to the invention in a third embodiment; and

FIG. 4 shows a schematic illustration of a device according to the invention in a fourth embodiment.

### DETAILED DESCRIPTION

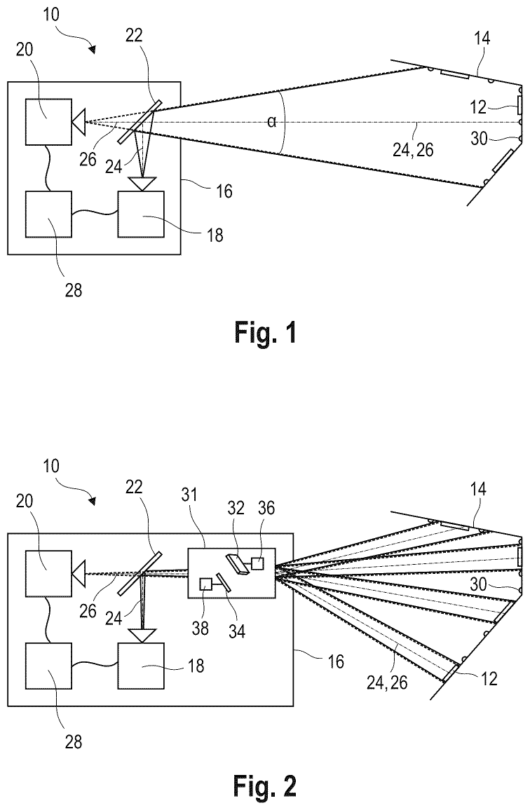

FIG. 1 shows a portable device 10 for displaying an item of graphical information 12 on a remote or distant object 14 in a simple first embodiment. This basic structure may be supplemented by further components, which will be discussed in more detail below in the description of further, particularly advantageous embodiments with reference to FIGS. 2 to 4.

A projector 18, in particular a video projector, for projecting the graphic information 12, and a camera 20 for capturing the position and/or location of the object 14 are accommodated in a portable housing 16. Instead of a video projector, a laser projector may in principle also be used, although in the following, embodiments with a video projector will be dealt with primarily. Further provided in the housing 16 is a semitransparent mirror 22, which partially reflects and partially transmits both the light emitted by the projector 18 and the light incident on the camera 20.

The projector 18, the camera 20, and the semitransparent mirror 22 are arranged relative to each other such that a first surface of the semitransparent mirror 22 is located in the beam path of the projector 18 and the second, opposite surface of the semitransparent mirror 22 is located in the viewing angle of the camera 20. In the exemplary embodiment illustrated in FIG. 1, the projector 18 and the camera 20 are oriented such that their optical axes 24 and, respectively, 26 are perpendicular to each other, and the semitransparent mirror 22 is arranged and oriented at the intersection point of the two optical axes 24, 26 such that it is inclined at 45° in relation to both optical axes 24, 26.

Owing to the semitransparent mirror 22, the optical axis 24 of the beam path, deflected by reflection, of the projector 18 is altered in such a way that it coincides with the optical axis 26 of the portion of the light transmitted by the semitransparent mirror 22 and incident on the camera 20. For the sake of simplicity, that area of the device 10 in which the optical axes 24, 26 are coaxial is referred to as the coaxial area of the device 10.

Basically, it is also possible to utilize the device 10 in such a way that the optical axis 24 of the beam path of the projector 18 transmitted by the semitransparent mirror 22 is directed onto the object 14. In this case, the portion of the light that is reflected by the semitransparent mirror 22 and is incident on the camera 20 is of interest.

In both cases, the beam path of the projector 18 is combined with the beam path of the camera 20 by means of the semitransparent mirror 22, so that an in-line arrangement of the projector 18 and the camera 20 is simulated.

A control device 28 is provided to control the projector 18 and the camera 20 and also to evaluate the images captured by the camera 20. The essential components of the control device 28 may be provided inside the housing 16 or—differently from what is shown in FIG. 1—outside the housing 16.

The projector 18 is intrinsically calibrated, i.e., the principal point, lens distortion, and focal length of the projector 18 are known. Similarly, the camera 20 is intrinsically calibrated, i.e., the principal point, lens distortion, and focal length of the camera 20 are also known. This intrinsic calibration is known and described, for example, in J. Weng, P. Cohen, M. Herniou: Camera Calibration with Distortion Models and Accuracy Evaluation; IEEE Transactions on Pattern Analysis and Machine Intelligence, Vol. 14, No. 10, pp. 965-980 (1992). The camera 20 is, moreover, extrinsically calibrated with respect to the projector 18, i.e., its pose (position/orientation) is known.

The camera 20 can therefore be used to determine the spatial relationship between the object 14 and the projector 18 (registration). This may also be done continuously (tracking). Methods based on markers or the like 30 (see, e.g., WO 2012/136345 A2) and markerless methods (see, e.g., WO 2022/136030 A2) come into consideration for this purpose.

This arrangement allows graphic information 12 to be projected onto the object 14. This graphic information 12 can be used to display digital contents in the correct position on the object 14 to the observer in terms of augmented reality.

The calibration of a 2D camera with respect to a projector is known, e.g., from WO 2012/136345 A2 and DE 10 2016 105 405 A1. It is based, in essence, on the observation of a plurality of projections in relation to precisely measured points on a planar or non-planar test field by means of the camera. This allows both the intrinsic and extrinsic parameters of a projector-camera system to be ascertained in one step. A prerequisite is a sufficient number of observations in a mathematically nondegenerate constellation so that the parameters to be identified are sufficiently determined (ideally overdetermined) and can be determined by means of iterative solving of the nonlinear functional relationship (bundle block adjustment).

Of particular importance here is the combination of the projector 18 and the camera 20 through the semitransparent mirror 22. Since from an optical point of view the projector 18 and the camera 20 are located in the same beam path, the camera 20 has exactly the same perspective on the object 14 as the projector 18. If the semitransparent mirror 22 is sufficiently thin and planar, there is basically no change in the calibration procedure described above for the projector-camera system.

While the device 10 is thus not suitable for performing depth measurement by triangulation of an element (point or similar) projected onto the surface of the object 14 (scanning, see, e.g., WO 2015/091291 A1), since the baseline (distance between two cameras or between a projector and a camera) necessary for this is missing, the object 14 can nonetheless be illuminated by means of the projector 18 and viewed from the exact same perspective. This is an advantage in particular if the object has a complex shape and the observable elements on the surface are highly dependent on the viewing angle. Therefore, the device 10 is suitable in particular for assessing the correct positioning of elements (e.g., add-on parts) on the surface of the object 14. The elements can be suitably illuminated by means of projection (structured illumination) so that they are reproduced in the camera image with high contrast. Since the perspective of the structured illumination and the observing camera 20 is identical, there are no parallax effects. This means that surfaces having complex shapes, differences in height due to elements mounted on the object surface, etc., do not result in shadowing. In particular, the illuminated surface can be photographed in its entirety. This allows image processing algorithms to be implemented to be particularly robust.

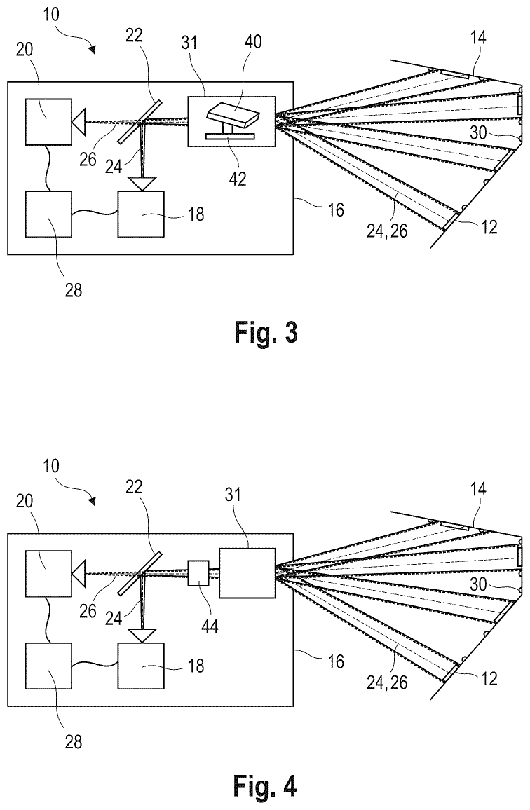

The device 10 thus makes it possible (i) to save on additional cameras and lighting by allowing different locations to be approached from only a single perspective and to be illuminated appropriately using the projector 18, e.g., for a robust image processing for the purpose of identifying/checking the correct assembly of add-on parts, and (ii) to make production or assembly more flexible by allowing unknown positions to be simply controlled digitally in advance (in comparison to the use of conventional templates), e.g. to display assembly instructions or positioning information (crosshairs, contours, etc.) for an exact positioning of add-on parts, or for displaying information to identify elements on a component (such as one hole among many into which a clip, screw, or the like is to be placed). While conventional templates have to be procured and kept in stock in order to be able to manufacture a particular product variant or implement a specific plan, the digital control of a “digital template” by means of the device 10 allows any product variant to be manufactured, provided that the 3D data therefor is available. The generation of the projection contents can, if required, also be fully automated, e.g. by automatically preparing and displaying the 3D contents on the basis of the component identification number and the parts list applicable thereto. This makes any manual setup process in a production line dispensable. It will be appreciated that, for the sake of simplicity, in FIG. 1 (and also in the further Figures), the projection cone of the projector 18 (solid lines) and the light incidence cone of the camera 20 (dashed lines) are identical in the coaxial area and outside the device 10. In this case, the focal lengths of the projector 18 and the camera 20 are identical. However, this is not absolutely necessary. Rather, different focal lengths may well be advantageous for certain applications. FIGS. 2 and 3 show extended embodiments of the portable device 10, in which the basic structure described above is combined with a scanning system 31 (shown symbolically).

In the variant shown in FIG. 2, two rotating mirrors 32, 34 are arranged in the coaxial area of the device 10, which are adapted to be deflected by two galvanometer drives 36, 38 (in short: galvos). More precisely, the first rotating mirror 32 can be rotated about a first axis and the second rotating mirror 34 can be rotated about a second axis that is at least approximately perpendicular to the first axis. The galvos 36, 38 are controlled by the control device 28.

By means of the rotating mirrors 32, 34, the common beam path of the projector 18 and the camera 20 can be deflected in two mutually perpendicular directions. This allows the area that can be reached by the beam path in the environment to be significantly expanded in that the nominal projection field of the projector 18 and/or the nominal view cone of the camera 20 is widened by means of deflection of the rotating mirrors 32, 34. Commonly used galvo scanning systems achieve deflection angles of +/−20°, which optically allows a range of 80° to be achieved (angle of incidence=angle of reflection, resulting in a doubling of the deflection).

Specifically, a very compact pico video projector 18 having low light output and a larger focal length (e.g., 5°, equivalent to an image width of approx. 17 cm at a projection distance of 2 m) and thus a smaller projection field at a given working distance can therefore be combined in the device 10. Pico video projectors that have a low light output are not only very inexpensive, but in addition also compact in design and, due to their low energy consumption, particularly economical. Owing to the lower waste heat, the device 10 is furthermore also much easier to cool. All in all, such an arrangement results in a very compact, lightweight unit that can be easily protected against environmental influences such as dust and moisture and is therefore inexpensive to manufacture, but is nevertheless capable of illuminating large areas.

The illumination here cannot be realized simultaneously across the entire area, which makes it unusable for some applications, such as when larger structures (e.g., a CAD layout for the precise arrangement of pre-cut parts on a table) need to be displayed at once. In many other applications, however, it is sufficient for the illumination to be performed sequentially (e.g., to display specific steps in a work instruction one after the other).

In the final analysis, the unit behaves like a flashlight that automatically shines where the observer wishes to look. The same light output per surface area is available for the respectively illuminated area (e.g., 500 ANSI lumens per 0.25 m²=2000 ANSI lumens per m²) as would be the case when illuminating a larger area with a significantly larger, more powerful, and more expensive device (e.g., 4000 ANSI lumens per 2 m²=2000 ANSI lumens per m²). Here, it is important to note that, as a guideline, at least three to five times the illuminance on the object surface, measured in lux, has to be applied in ANSI lumens per m² to achieve a high-contrast display. For typical workplace environments, the illuminance provided by artificial light is at least 500 lux, and significantly more in some workplaces. In work environments where natural sunlight can penetrate, the illuminance may be 2000 lux and more. It is therefore easily apparent that there are narrow limits in practice to a complete, high-contrast illumination of object surfaces using video projectors (e.g., for a table measuring 2 m×2 m=4 m², even with moderate illumination of only 500 lux, at least 4×500 lumens/m²×4=8000 ANSI lumens are required, which already necessitates a sizeable projector). This does not even take into account the fact that the commonly used 4:3, 16:9, or 16:10 image formats of commercially available projectors do not necessarily match the object surface, which may result in a significantly lower net luminous efficacy.

A further advantage over the first embodiment resides in that the device 10 with the scanning system 31 consumes only little power owing to the low light output of the pico video projector 18, which not only benefits the environment but also makes it much easier to cool the device 10 due to lower waste heat. Conventional video projectors are typically air-cooled, with no decoupling existing between the environment and the interior of the housing. Such devices are therefore typically only classified in protection class IP20 (protected against solid foreign bodies having a diameter ≥12.5 mm; protected against contact with a finger; no protection against water). In particular environmental influences such as metallic dust and aerosols pose a problem for the longevity of the devices. This means that conventional video projectors cannot be used in dirty environments such as welding shops, construction sites, etc. The device 10, on the other hand, can be designed to be compact, cost-effective, and yet dual-circuit due to its low heat development, so that dirt can be kept away from the interior of the housing and thus from critical components. This particularly advantageous embodiment is therefore suitable for use as an operator assistance system in a wide variety of environments.

Another advantage in comparison to the first embodiment is that, given the resolution of the projector 18 of the device 10, the higher focal length provides a higher number of pixels per area (DPI) on the object surface. This allows thinner, more delicate, and therefore more precise projections to be displayed.

In a particularly advantageous variant of the device 10, both the projector 18 and the camera 20 are designed with a high focal length. Although this reduces the viewing cone available for simultaneous observations of the object space by the camera 20, the usable resolution on the object surface is increased at the same time. This means that finer structures can still be resolved. This considerably increases the quality of the data available for image processing algorithms without the total (sequentially) observable areas being reduced. This offers substantial advantages for all applications based on an observation by a camera. This includes not only the precise referencing of the projector 18 relative to the object 14 (or tracking), but also the determination of properties of the object 14, such as the determination of the correct and precise mounting of an add-on part to a workpiece. The higher available resolution can thus significantly increase the validity of such image processing methods.

As already indicated, a laser projector—also operating on the basis of a galvo scanner—can be provided here as the projector 18 instead of a video projector. In such an embodiment, a point laser source is deflected in two mutually perpendicular directions by means of two mirrors such that the observer has the impression of a stationary laser contour. Such galvo-assisted laser projectors are frequently used in industry, for example to transfer precise positionings or trimmings to planar tables or to complex-shaped components. Galvos typically have a very high resolution of at least 2¹⁶ bits, which extends to the usable angle of deflection of +/−20° and the resulting field of view of 80°×80°. In comparison, the horizontal resolution of a 4K video projector is only 4096 or 3840 (depending on the image format). However, if this resolution is distributed over a viewing angle of only 5° instead of 80°, this results in an effective resolution of approx. 4000*(80/5)=64000 for the device 10, which approximately corresponds to the high resolution of 216 bits of the laser projector.

For a better understanding, it should be added that the resolution of the galvos 36, 38 is not decisive for the resulting resolution of the overall layout, since they only need to roughly align the field of view of the video projector 18 with the object 14 such that the desired target area (ROI) on the object 14 is completely covered by the usable field of view of the projection. Then, only the resolution of the video projection that is available there is decisive. It is ensured by means of calibration and appropriate control that the respective responsible pixel is associated with the desired target coordinate on the object 14.

If the device 10 is to be designed for larger working distances, it is only necessary to select a larger focal length for the projector 18, resulting in a smaller viewing angle (e.g., 2.5° instead of 5°). This means that the same effective resolution is available at a larger working distance as well. This constitutes a further advantage of the device 10 compared to the above-mentioned laser projectors, the effective resolution of which is, in fact, always obtained by the resolution of the galvos as viewed across the entire image field (e.g., 216 for 80°), which results in the discretization effect becoming increasingly greater as the working distance increases.

Since the rotating mirrors 32, 34 of the device 10 do not have to move at a high frequency to create the impression of a stationary contour, but merely have to shift the image section of the video projector 18 to the respectively desired position, for which slow movements are sufficient, the requirements for the galvos 36, 38 are also considerably lower. Markedly less expensive models with low acceleration values may be employed. In addition, the slow movement and the resulting low forces also lead to significantly less wear on the mechanical parts. This allows an equally precise system, which in addition is also more durable, to be manufactured at a more favorable price.

Since the device 10 is not able to illuminate, and thus see, all areas at the same time, the capability for dynamic tracking of objects is somewhat limited. For the referencing or tracking of objects, typically the observations of a plurality of markers or other distinctive geometric elements, such as edges, corners, holes, etc., or else distinctive texture elements, such as light/dark transitions, so-called features, generally marked here by reference numeral 30, are required (at least four on planar surfaces or six on non-planar surfaces, distributed over the object surface). Due to the deflection of the rotating mirrors 32, 34, these observations can only be made sequentially. The latency between two observations here depends on the design of the mirror system (size/weight of the rotating mirrors 32, 34 and capacity of the galvos 36, 38) and also on the angle by which the rotating mirrors have to be moved between the two observations. In the worst case, the view cone has to be moved, for example, from the far left to the far right or from the very bottom to the very top. In the case of simultaneous movement, “observations” of relevant elements on the object surface can therefore not be performed at the same time, but only one after the other. Mathematically speaking, it is therefore not possible to carry out four or six observations of reference elements simultaneously when assuming moving objects. In the case of slower movements, on the other hand, the four or six observations are sufficiently “simultaneous” for robust referencing. For stationary objects, there are no restrictions at all. The technology may also be employed in the case of faster-moving objects (such as on an assembly line). The inconsistency in the four or six observations as caused by the movement of the object 14 then leads to a reduction in the achievable accuracy in the continuous pose determination. In the case of uniform movements (as are typically found in manufacturing environments, assembly lines, etc.), the inconsistency caused by the time offset of the observations can even be completely compensated for by a Kalman filter using a suitable motion model. Assuming uniform or uniformly accelerated movements, this achieves the same precision as with stationary objects.

In a further expansion stage, the device 10 can be implemented with a so-called depth camera (3D camera or time-of-flight (ToF) camera) rather than with a conventional 2D camera. This expands the options, because, as already discussed above, arrangements equipped with 2D cameras are not capable of performing triangulation-based depth measurements due to the absence of a baseline. This restriction is eliminated by the use of a ToF-based depth camera. The measuring principle employed here is a time-of-flight measurement of the light emitted by the ToF camera, reflected by the object surface, and finally received again by the ToF camera. The depth results from the time difference between the emitted and the received light; the baseline plays no role in this measuring principle. This removes the above-mentioned disadvantage of the arrangement of the projector 18 and the camera 20 in the same beam path. ToF cameras typically operate with invisible infrared illumination. The beam path, in particular the semitransparent mirror 22, has to be appropriately designed such that infrared radiation is partially transmitted in both directions, as is the visible light.

If the device 10 provides for a deflection of the beam path of at least the projector 18 or, furthermore, also of the camera 20, the calibration of the optical components turns out to be more complicated. It is no longer sufficient to know the intrinsic properties of the projector 18 and the camera 20, as well as the extrinsic relationship of these two components, taking into account the semitransparent mirror 22. Added to this are the imaging properties of the two rotating mirrors 32, 34. Mathematically, this can be described by the models that are described, e.g., in Eisert, Peter; Polthier, Konrad; Hornegger, Joachim: A mathematical model and calibration procedure for galvanometric laser scanning systems; Vision, Modeling, and Visualization. 2011, pp. 207-214. These models are also employed for the deflection of point laser sources in laser projectors. However, unlike the point laser source, the video projector 18 generates an areal image. In a naive implementation, a point (such as the center of an image or the principal point) can be regarded to be analogous to the point laser source. For pixels with an increasing distance from this one point, for a given deflection of the rotating mirrors 32, 34 this would therefore result in an increasing error in the mathematical model. In order to be able to use a precise mathematical model for all pixels, the calibration therefore has to take into account the entire projection area for every possible mirror deflection in order to achieve maximum precision. Among other things, this is achieved by increasing the number of measurements. Just as the deflection of the point-shaped laser sources of different laser projectors, each with a characteristic angle of incidence of the point laser on the first and second rotating mirrors, can be calibrated device by device, this can also be done within the device 10 with the video projector 18, wherein, as it were, the different angles of incidence of the point light source on the first and, respectively, second rotating mirror 32, 34 are present in the form of different pixels in a single device. In practice, calibration does not have to be performed separately for each pixel. It is sufficient to calibrate for a few pixels distributed over the image and to interpolate the optical path for intermediate pixels.

FIG. 3 shows a further embodiment of the device 10, in which the structure shown in FIG. 1 is combined with a scanning system 31. Here, the scanning system 31 is formed by a special scanning mirror 40 having a drive in the form of a deflection mechanism 42 that is adapted to be adjusted by electric stepper motors. Compared to the embodiment described above, the number of mirrors of the scanning system 31 is thus reduced from two to one. Scanning systems having only one deflectable scanning mirror are available for larger projectors, e.g., from Dynamic Projection Institute under the name “Mirror Head.”

Using such a scanning mirror 40, the projection of the projector 18 can be deflected considerably further than would be feasible when using the lens shift functionality typically installed in commercially available projectors. The scanning mirror 40 can be deflected about two mutually perpendicular axes by the deflection mechanism 42 controlled by the control device 28. Since the deflection mechanism 42 is more complex compared to the galvos 36, 38 and has a correspondingly greater mass, the frequency of the possible mirror movements is reduced. However, this is not a problem for some (static or slow-moving) applications.

The available scanning mirror systems are not calibrated, but the image can be directed to different locations in space in a reproducible manner. Since the scanning mirror 40 and typically also the projection surface are planar, the perspectively distorted image can be rectified again using a simple homography. This is achieved without any in-depth mathematical 3D calibration by appropriate manual adjustment of the four image corner points in the respective horizontal or vertical deflection. It is sufficient to be able to align the image reproducibly to the same area at any time “at the push of a button”.

In the context of this invention, such a scanning system 31 having a scanning mirror 40 constitutes a special case of the scanning system 31 with two rotating mirrors 32, 34 described above, in which the mirror distance is 0. This eliminates one of the parameters that needs to be calibrated as part of the calibration of two-mirror systems. As a result, significantly larger opening angles of up to 180° are possible, which is advantageous in the example of the aircraft fuselage barrel (see above). The entire half-shell can be reached laterally from a single position.

In another particularly advantageous variant, the scanning mirror 40 is not operated mechanically by means of moving parts, but is designed as a so-called MEMS (microelectromechanical system). The scanning mirror 40 is then arranged in the beam path of the projector 18 and the camera 20 at an inclination of 45° (in the zero position). The disadvantage is that the inclined mounting of the scanning mirror 40 results in a strong perspective, with the resolution of the image decreasing as the deflection increases. The advantage is that there are no mechanical parts and therefore no parts subject to wear. The system is altogether more compact. In conjunction with the arrangement described at the outset of the projector 18 and the camera 20 in a beam path, the invention can thus also be implemented by means of the MEMS.

Finally, FIG. 4 shows a further particularly advantageous embodiment in which the combined beam path of the projector 18 and camera 20 can be focused and zoomed by means of a lens unit 44. This allows variable working distances to be realized. If the lens unit 44 is motor-driven, different working distances can be mapped in an automated manner in a single process. When using such a lens unit 44, lenses on the projector 18 and the camera 20 can, where appropriate, be dispensed with entirely, so that the device can be made even simpler and more compact.

In particular for simpler applications, instead of a video projector or a laser projector unit having a point laser source, which has to be deflected rapidly by means of a galvo scanner in order to create the impression of a stationary projection on a component for the observer, the projector 18 employed may, alternatively, also be a low-cost light source which projects a simple geometric shape, such as a circle or a cross, by means of which an element or a location on the component can be unambiguously marked. Such a light source may, in particular, be an LED pattern projector, which can generate precise, intense, and uniform lines, grids, crosses, and point clouds by means of easily exchangeable pattern masks, wherein the different masks can be integrated using plug & play. Alternatively, the light source used may also be a laser diode which can generate various patterns by means of a diffractive optical element.

The advantage of such a configuration resides in that, instead of using mirrors that are rapidly moved by means of two galvo scanners, a slower mechanism is sufficient for deflecting the light beam, since it is not necessary to achieve the impression of a stationary contour, but rather only the pattern already emerging from the light source used needs to be aligned with the desired position on the component. Such a slow mechanism can be achieved by means of one or also two mirrors (see discussion in the present patent application) and is possibly more cost-effective to realize and, due to lower acceleration values, can also be realized involving less wear, thereby allowing longer service lives to be achieved. The semitransparent mirror 22 can be of various types. Some preferred variants will be discussed in more detail below.

The ratio of transmitted to reflected light (reflection/transmission) is typically about 50:50, although in principle a different ratio can also be selected depending on the application.

The semitransparent mirror 22 may be realized with or without a polarizing filter. A polarizing filter is able to minimize reflections on reflective surfaces, which results in more robust measurements and higher data quality being achieved.

The wavelength range in which the semitransparent mirror 22 is transmissive should be matched to the projector 18 and the camera 20 that are used. By default, all typical wavelength ranges could be transmitted.

Depending on the embodiment variant, in particular the following advantageous combinations can thus be defined:
2D camera+video projector: semitransparent mirror 22 is transmissive to visible light.
2D camera+monochromatic LED projector or laser diode: semitransparent mirror 22 is “narrowband,” transmissive only in the wavelength range of the light source.
3D ToF camera+video projector: semitransparent mirror 22 is transmissive to visible light and infrared light.
3D ToF camera+monochromatic LED projector or laser diode: semitransparent mirror 22 is “narrowband,” transmissive only in the wavelength range of the light source and to infrared light.
2D camera+monochromatic video projector: semitransparent mirror 22 is “narrowband,” transmissive only in the wavelength range of the light source (see also blue light scanner from photogrammetric measuring technology, particularly high signal-to-noise ratio for measuring tasks).
3D camera+monochromatic video projector: semitransparent mirror 22 is “narrowband,” transmissive only in the wavelength range of the light source (see also blue light scanner from photogrammetric measuring technology, particularly high signal-to-noise ratio for measuring tasks), and to infrared light.
2D camera+laser diode with dual function of “projection” and “for laser distance measurement”: semitransparent mirror 22 is “narrowband”, transmissive only in the wavelength range of the light source.

In general, the following applies: the smaller the wavelength range of light that can pass through the semitransparent mirror 22, the better the signal-to-noise ratio. However, the display quality then suffers if no multicolor display is possible.

### LIST OF REFERENCE NUMBERS

10 device
12 graphic information
14 object
16 housing
18 projector
20 camera
22 semitransparent mirror
24 optical axis of the projector
26 optical axis of the camera
28 control device
30 marker
31 scanning system
32 first rotating mirror
34 second rotating mirror
36 first galvanometer drive
38 second galvanometer drive
40 scanning mirror
42 deflection mechanism
44 lens unit

1. A portable device for displaying graphic information on a remote object, comprising:
a video projector for projecting the graphic information,
a camera for capturing a position and/or location of the remote object,
a semitransparent mirror having a first surface and an opposite second surface,
a control device for controlling the projector and the camera and for evaluating the images captured by the camera, and
a portable housing in which at least the projector the camera and the semitransparent mirror are accommodated,
wherein the projector, the camera and the semitransparent mirror arranged in relation to each other such that the first surface of the semitransparent mirror is located in a beam path of the projector and the second surface of the semitransparent mirror is located in a viewing angle of the camera, and that in a coaxial area of the device
either an optical axis of the beam path of the projector deflected by reflection by the semitransparent mirror is coaxial with the an optical axis of the an incidence of light on the camera transmitted by the semitransparent mirror,
or the optical axis of the beam path of the projector transmitted by the semitransparent mirror is coaxial with the optical axis of the incidence of light on the camera deflected by reflection by the semitransparent mirror.

2. The device according to claim 1, wherein essential components of the control device are not accommodated in the housing.

3. The device according to claim 1, wherein provided in the coaxial area of the device is a mirror arrangement which is adapted to be moved by a drive and by means of which the coaxial optical axes of the projector and of the camera can be jointly deflected in different spatial directions, the drive being controlled by the control device.

4. The device according to claim 3, wherein the mirror arrangement includes two rotating mirrors and the drive includes two galvanometer drives.

5. The device according to claim 3, wherein the mirror arrangement includes a scanning mirror that is rotatable about at least two axes.

6. The device according to claim 5, wherein the scanning mirror is rotatably mounted in a holder that is attached to the projector.

7. The device according to claim 3, wherein provided in the coaxial area of the device is a lens unit by means of which the beam path of the projector and the incidence of light on the camera can be automatically focused and/or automatically zoomed at a same time.

8. The device according to claim 7, wherein apart from the lens unit in the coaxial area of the device the projector and the camera do not have lenses of their own.

9. The device according to claim 1, wherein the projector comprises a pico video projector unit.

10. The device according to claim 1, wherein the projector comprises a laser projector unit, in particular having a point laser source.

11. The device according to claim 1, wherein the projector comprises a light source that projects a simple geometric shape, wherein the light source is an LED pattern projector unit that can generate various shapes by means of interchangeable pattern masks, or a laser diode unit that can generate various patterns by means of a diffractive optical element.

12. The device according to claim 1, wherein the projector comprises at least two of the following projector units: pico video projector unit; laser projector unit; LED pattern projector unit;
laser diode unit.

13. The device according to claim 1, wherein the camera comprises a depth camera.

14. The device according to claim 1, wherein a laser rangefinder is provided in addition to or instead of the camera.

15. The device according to claim 1, wherein, in addition to the camera, at least one further camera or a laser rangefinder is provided.

16. The device according to claim 10, wherein a laser rangefinder is provided in addition to or instead of the camera, and wherein the point laser source of the projector is also part of the laser rangefinder and is used for a measurement of a distance of the object.

17. The device according to claim 1, wherein the semitransparent mirror is provided with a polarizing filter.
